(19) United States
(12) Patent Application Publication
(10) Pub. No.: US 2005/0170994 A1
(43) Pub. Date: Aug. 4, 2005

(54) Fabric care compositions comprising aminosilicone

(76) Inventors: Arturo Luis Casado-Dominguez, Brussels (BE); Shulin Larry Zhang, Wset Chester, OH (US); Tamara Ancaer, Liedekerke (BE); Mark Robert Sivik, Mason, OH (US); Eric Christopher Wells, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/978,942

(22) Filed: Nov. 1, 2004

Related U.S. Application Data
(60) Provisional application No. 60/516,468, filed on Oct. 31, 2003.

(51) Int. Cl. C11D 3/50

(52) U.S. Cl. 510/466; 510/499

(57) ABSTRACT

Fabric care compositions comprise aminosilicone having an amino content ratio defined by a ratio of the amine containing units to the total number of units, wherein the amino content ratio is from about 1:11 to about 1:269, emulsifier, and fabric softening active. The aminosilicone materials in fabric care compositions can provide a number of benefits including improved fabric softness, wrinkle reduction after drying, ease of ironing, in-wear shape retention, fabric elasticity, fabric tensile strength, fabric tear strength, and/or color protection. A process of making an aminosilicone emulsion comprises the step of mixing an aminosilicone having an amino content ratio of from about 1:11 to about 1:269 with a cationic emulsifier. The invention further relates to a process of making the fabric care compositions.

### CROSS REFERENCE TO RELATED APPLICATIONS

This application claims priority to U.S. Provisional Application Ser. No. 60/516,468 filed Oct. 31, 2003, the disclosure of which is incorporated by reference herein.

### FIELD OF INVENTION

The present invention relates to fabric care compositions comprising aminosilicone. The present compositions are preferably used to treat fabrics to provide improved fabric softness, wrinkle reduction after drying, ease of ironing, in-wear shape retention, fabric elasticity, fabric tensile strength, fabric tear strength, and/or color protection.

### BACKGROUND OF THE INVENTION

Fabric care compositions include fabric softening compositions which are generally used during the rinse cycle or drying cycle of a typical laundry process to provide improved softness and freshness to the fabrics being laundered. If added during the rinse cycle, the fabric care compositions are typically liquid compositions. If added during the drying cycle, the fabric care compositions are typically solid compositions that are incorporated onto a nonwoven substrate that is placed in the laundry dryer.

Aminosilicones have previously been utilized in fabric care compositions for providing benefits to fabrics. For example, U.S. Pat. No. 4,800,026 discloses fabric care compositions comprising curable amine functional silicones for wrinkle reduction. The curable aminosilicones of the '026 patent have the empirical formula ((RO)R′₂SiO_{1/2})ₓ(R′₂SiO_{2/2})_{Y}(R″SiO_{3/2})_{Z}, wherein X is equal to Z+2; Y is at least 3; Z is zero or at least 1; R is a hydrogen or a C₁₋₂₀ alkyl; and R′, R″ is a C₁₋₂₀ alkyl or amine group. The curable aminosilicones are in the form of an aqueous emulsion containing 10% to 50% of emulsifier, by weight of the aminosilicone. The curable aminosilicone has an average molecular weight of from 1,000 to 100,000, with lower molecular weight aminosilicones being preferred. The curable aminosilicones can be incorporated into fabric softener or detergent compositions.

However, aminosilicones previously utilized in fabric care compositions typically have several negatives associated with their use in treatments for fabrics. For example, many aminosilicone materials have a negative effect of causing the yellowing of white or lightly colored fabrics and/or increasing the hydrophobicity of the fabrics being treated.

There remains a need to develop an improved fabric care composition that provides improved fabric feel and/or softening, while limiting negative effects on fabrics such as yellowing and/or increasing the hydrophobicity of fabrics.

### SUMMARY OF THE INVENTION

The present invention relates to fabric care compositions comprising aminosilicone having an amino content ratio, defined by a ratio of the amine containing units to the total number units, of from about 1:11 to about 1:269, emulsifier, and fabric softening active. The incorporation of these aminosilicone materials in fabric care compositions can provide a number of benefits including improved fabric softness, wrinkle reduction after drying, ease of ironing, in-wear shape retention, fabric elasticity, fabric tensile strength, fabric tear strength, and/or color protection. Furthermore, these aminosilicone materials limit the negative effects typically associated with previously utilized aminosilicone materials such as yellowing and/or increasing the hydrophobicity of fabrics.

The present invention further relates to a process of making an aminosilicone emulsion. In a preferred process of manufacture, an aminosilicone emulsion is made by mixing an aminosilicone having an amino content ratio of from about 1:11 to about 1:269 with a cationic emulsifier. A preferred cationic emulsifier is cetyltrimethylammonium chloride.

The present invention further relates to a process of making fabric care compositions comprising aminosilicone having an amino content ratio of from about 1:11 to about 1:269, emulsifier, and a fabric softening active.

### DETAILED DESCRIPTION OF THE INVENTION

Aminosilicone

The present compositions comprise aminosilicones having certain amino content, viscosity, and/or branching. The aminosilicone of the present invention can be a linear or branched structured aminosilicone polymer comprised of the following base units:
(R¹R²R³SiO_{1/2})ₚ(R⁴R⁴SiO_{2/2})ₘ[R⁴Si(L-NR⁵R⁶)O_{2/2}]ₐ[Si(K—NR⁷R⁸)O_{3/2}]_{b}[R⁴SiO_{3/2}]_{c}
wherein R¹, R², R³ and R⁴ can independently be (1) C₁-C₂₂ linear or branched, substituted or unsubstituted hydrocarbyl moiety, or (2) —O—R¹¹, —O—R¹², —O—R¹³, and —O—R¹⁴, where R¹¹, R¹², R¹³, and R¹⁴ are H or C₁-C₂₂ linear or branched, substituted or unsubstituted hydrocarbyl moiety.

The nomenclature “SiO_{n/2}” means the ratio of oxygen atoms to silicon atoms, i.e., SiO_{l/2} means one oxygen atom is shared between two silicon atoms. Likewise, SiO_{2/2} means two oxygen atoms are shared between two silicon atoms and, SiO_{3/2} means three oxygen atoms are shared between two silicon atoms.

L and K can independently be C₁-C₂₂ linear or branched, substituted or unsubstituted hydrocarbyl moiety. Preferably L and K are independently C₁-C₁₂ linear or branched, substituted or unsubstituted hydrocarbyl moiety. More preferably L and K are independently C₁-C₄ linear or branched, substituted or unsubstituted hydrocarbyl moiety. Most preferably L and K are independently methylene, ethylene, propylene, 2-methylpropylene, butylene, octadecylene, or 3-(2,2′,6,6′-tetramethyl-4-oxy-piperidyl)propyl.

R⁵, R⁶, R⁷ and R⁸ can independently be H or C₁-C₂₂ linear or branched, substituted or unsubstituted hydrocarbyl moiety, including nitrogen and other heteroatom containing substituent. Preferably R⁵, R⁶, R⁷ and R⁸ are independently H or C₁-C₁₂ linear or branched, substituted or unsubstituted, alkyl or aryl hydrocarbyl moiety, including nitrogen containing substituent and oxygen containing substituent. Most preferably, R⁵, R⁶, R⁷ and R⁸ are independently H, phenyl, cyclohexyl, phenyl, 2-aminoethyl, 2-(N-2-aminoethyl)aminoethyl, 2-[N-2-(N-2-aminoethyl)aminoethyl]aminoethyl, 2-(N-phenyl)aminoethyl, 2-(N-cyclohexyl)aminoethyl, polyethyleneoxide, polypropyleneoxide, polyethyleneoxide-co-polypropyleneoxide, or polyethyleneoxide-co-polypropyleneoxide-co-polyethyleneamine.

A non-limiting example list of the most preferred amino-functional groups described by
—L—NR⁵R⁶ and —K—NR⁷R⁸ are independently:
   —CH₂—NH₂
   —CH₂—NH—C₆H₅
   —CH₂—NH—C₆H₁₁
   —CH₂—NH—(C₂H₄O)ⱼ[C₂H₃(CH₃)O]ₖH
   —C₃H₆—NH₂
   —C₃H₆—NH—C₆H₅
   —C₃H₆—NH—C₆H₁₁
   —C₃H₆—NH—(C₂H₄O)ⱼ[C₂H₃(CH₃)O]ₖH
   —C₃H₆—NH—(C₂H₄—NH)ᵢ(C₂H₄O)ⱼ[C₂H₃(CH₃)O]ₖH
   —C₃H₆—NH—C₂H₄—NH₂
   —C₃H₆—NH—C₂H₄—NH—C₆H₅
   —C₃H₆—NH—C₂H₄—NH—C₆H₁₁
   —C₃H₆—NH—C₂H₄—NH—(C₂H₄O)ⱼ[C₂H₃(CH₃)O]ₖH₂
   —C₃H₆—NH—C₃H₆
   —C₃H₆—O—C₅H₄(CH₃)₄NH
   —CH₂CH(CH₃)CH₂—NH—C₂H₄—NH₂
   —CH₂CH(CH₃)CH₂—NH—C₂H₄—NH—C₆H₅
   —CH₂CH(CH₃)CH₂—NH—C₂H₄—NH—C₆H₁₁
   —C₃H₆—NH—C₂H₄—NH—C₂H₄—NH₂
   —C₁₈H₃₆—NH₂
   The indices i, j, and k are numbers independently from 0 to 20, and the sum of i+j+k is preferred from 0 to 30.

The indices a, b, c, m, and p are numbers independently from 0 to 6000, wherein p is equal to 2+b+c. T is equal to the sum of a+b+c+m+p. The preferred range of T is from about 10 to about 6500, which corresponds to an aminosilicone having a total weight average molecular weight of less than about 500,000.

An important feature of the aminosilicone of the present invention is the amino content of the polymer which is defined by a ratio of the amine containing units to the total number of units:
(a+b):T
The preferred amino content ratio (a+b):T is from about 1:11 to about 1:269, more preferably from about 1:16 to about 1:135, and even more preferably from about 1:22 to about 1:68.

Alternatively, the amino content of the polymer can be defined by the % nitrogen content of the polymer (% N) or by the milliequivalents of HCl needed to neutralized one gram of polymer (N meq/g).

A non-limiting example of an aminosilicone composed of units wherein R¹, R², R³, and R⁴ are CH₃, L is propyl, b and c indices are equal to zero, and R⁵ and R⁶ are H, the preferred amino content can be described as follows:

| | | Amino content |
|---|---|---|
| Amino ratio as | Amino content as | as |
| (a + b):T | N% | N meq/g |
| 1:269 | 0.07 | 0.05 |
| 1:135 | 0.14 | 0.10 |
| 1:68 | 0.28 | 0.20 |
| 1:22 | 0.84 | 0.60 |
| 1:16 | 1.12 | 0.80 |
| 1:11 | 1.54 | 1.10 |

An important feature of aminosilicones of the present invention which are branched is the degree of branching, which can be described by the branching ratio:
(c+b):T
For branched aminosilicone polymers the preferred branching ratio is from about 1:45 to about 1:500.

The viscosity of the non-cured and non-emulsified aminosilicone fluid will typically be in the range of from about 200 to about 10,000 centipoise (“cps”), preferably from about 500 to about 5000 cps, and more preferably from about 800 to about 3000 cps.

The aminosilicone of the present invention can be a single polymer or a mixture of polymers, including a mixture of polymers wherein one of the polymers contains no aminofunctionality, that is a+b+c=0, e.g. a polydimethylsiloxane polymer.

Suitable aminosilicones are commercially-available from Dow Corning under the trade names DC2-8822A and DC2-8040.

Aminosilicone is typically incorporated in the present compositions at a level of from about 0.05% to about 30%, preferably from about 0.08% to about 10%, and more preferably from about 0.5% to about 6%, by weight of the composition.

Emulsifier

The present compositions further comprise an emulsifier, preferably selected from the group consisting of cationic emulsifier, nonionic emulsifier, and mixtures thereof. The emulsifier is utilized to emulsify the aminosilicone to form an aminosilicone emulsion.

Non-limiting examples of cationic emulsifiers suitable in the present compositions include monoalkyl quaternary ammonium compounds such as cationic emulsifiers having the general formula:
{R₃—N⁺—[(CH₂)ₙ—Y —R¹}X⁻
wherein each R substituent is independently either hydrogen, a short chain C₁-C₆, preferably C₁-C₃ alkyl or hydroxyalkyl group, e.g., methyl, ethyl, propyl, hydroxyethyl, and the like, poly(C₂₋₃ alkoxy), preferably polyethoxy, benzyl, or mixtures thereof; each n is from 1 to about 4, preferably 2; each Y is —O—(O)C—, —C(O)—O—, —NR—C(O)—, or —C(O)—NR—; the sum of carbons in each R¹, plus one when Y is —O—(O)C— or —NR—C(O)—, is C₈-C₂₂, preferably C₈-C₂₀, with each R¹ being a hydrocarbyl, or substituted hydrocarbyl group, and X⁻ can be any compatible anion, preferably, chloride, bromide, methylsulfate, ethylsulfate, sulfate, and nitrate, more preferably chloride or methyl sulfate. Other monoalkyl quaternary ammonium compounds suitable as cationic emulsifiers have the formula:
[R₃—N⁺—R¹]X⁻
wherein each R, R¹, and X⁻ have the same meanings as before. Still other monoalkyl quaternary ammonium compounds suitable as cationic emulsifiers in the present compositions are described in detail in U.S. Application Publication 2003/0060390 A1. A preferred example of a cationic emulsifier is cetyltrimethylammonium chloride (commercially available under the trade name ARQUAD® 16/50 from Akzo-Nobel).

Non-limiting examples of nonionic emulsifiers suitable in the present compositions include alkoxylated nonionic surfactant, especially an ethoxylated nonionic surfactant. Suitable nonionic emulsifiers further include nonionic surfactants derived from saturated and/or unsaturated primary, secondary, and/or branched, amine, amide, amine-oxide fatty alcohol, fatty acid, alkyl phenol, and/or alkyl aryl carboxylic acid compounds, each preferably having from about 6 to about 22, more preferably from about 8 to about 18, carbon atoms in a hydrophobic chain, more preferably an alkyl or alkylene chain, wherein at least one active hydrogen of said compounds is ethoxylated with ≦50, preferably ≦30, more preferably from about 5 to about 15, and even more preferably from about 8 to about 12, ethylene oxide moieties to provide an HLB of from about 8 to about 20, preferably from about 10 to about 18, and more preferably from about 11 to about 15. Such nonionic emulsifiers include those commercially-available from Shell Chemicals under the trade name NEODOL®. Suitable emulsifiers further include sorbitan fatty acid esters (commercially-available from Uniqema under the trade name SPAN® series), polyoxyethylene sorbitan fatty acid esters (commercially-available from Uniqema under the trade name TWEEN® series), polyoxyethylene fatty acid esters (commercially-available from Uniqema under the trade name CIRRASOL® series), polyoxyethylene alcohols (commercially-available from Uniqema under the trade names BRU® and RENEX® series). Preferred nonionic emulsifiers include polyoxyethylene(12)tridecyl ether (commercially-available from Uniqema under the trade name RENEX® 30), NEODOL® 91-5, and mixtures thereof.

Mixtures of emulsifiers can also be utilized. In a preferred embodiment, the present compositions comprise a mixture of cationic and nonionic emulsifiers.

Emulsifiers are incorporated in the present compositions at a level of from about 0.01% to about 5%, preferably from about 0.03% to about 2%, and more preferably from about 0.05% to about 1%, by weight of the composition.

Fabric Softening Active

The present compositions further comprise fabric softening active. Typical minimum levels of incorporation of the fabric softening active in the present compositions are at least about 2%, preferably at least about 4%, and more preferably at least about 8% (especially for concentrated compositions), by weight of the composition, and the typical maximum levels of incorporation of the fabric softening active in the present compositions are less than about 90%, preferably less than about 40%, more preferably less than about 30% and even more preferably less than about 20%, by weight of the composition.

Preferred Diester Quaternary Ammonium (DEQA) Compounds

The fabric softening active herein can preferably be a DEQA compound. The DEQA compounds encompass a description of diamido fabrics softener actives as well as fabric softener actives with mixed amido and ester linkages.

A first type of DEQA (“DEQA (1)”) suitable as a fabric softening active in the present compositions includes compounds of the formula:
{R₄-m —N⁺—[(CH₂)ₙ—Y—R¹]ₘ}X⁻
wherein each R substituent is either hydrogen, a short chain C₁-C₆, preferably C₁-C₃ alkyl or hydroxyalkyl group, e.g., methyl (most preferred), ethyl, propyl, hydroxyethyl, and the like, poly(C₂₋₃ alkoxy), preferably polyethoxy, group, benzyl, or mixtures thereof; each m is 2 or 3; each n is from 1 to about 4, preferably 2; each Y is —O—(O)C—, —C(O)—O—, —NR—C(O)—, or —C(O)—NR— and it is acceptable for each Y to be the same or different; the sum of carbons in each R¹, plus one when Y is —O—(O)C— or —NR—C(O)—, is C₁₂-C₂₂, preferably C₁₄-C₂₀, with each R¹ being a hydrocarbyl, or substituted hydrocarbyl group; it is acceptable for R¹ to be unsaturated or saturated and branched or linear and preferably it is linear; it is acceptable for each R¹ to be the same or different and preferably these are the same; and X⁻ can be any softener-compatible anion, preferably, chloride, bromide, methylsulfate, ethylsulfate, sulfate, phosphate, and nitrate, more preferably chloride or methyl sulfate. Preferred DEQA compounds are typically made by reacting alkanolamines such as MDEA (methyldiethanolamine) and TEA (triethanolamine) with fatty acids. Some materials that typically result from such reactions include N,N-di(acyl-oxyethyl)-N,N-dimethylammonium chloride or N,N-di(acyl-oxyethyl)-N,N-methylhydroxyethylammonium methylsulfate wherein the acyl group is derived from animal fats, unsaturated, and polyunsaturated, fatty acids, e.g., oleic acid, and/or partially hydrogenated fatty acids, derived from vegetable oils and/or partially hydrogenated vegetable oils, such as, canola oil, safflower oil, peanut oil, sunflower oil, corn oil, soybean oil, tall oil, rice bran oil, etc. Non-limiting examples of suitable fatty acids are listed in U.S. Pat. No. 5,759,990 at column 4, lines 45-66. Those skilled in the art will recognized that materials made from such process can comprise a combination of mono-, di-, and tri-esters depending on the process and the starting materials. Materials from this group preferred for the present invention include those comprising a high level of diester content, preferably more than 45% of the total active weight and more preferably at least about 80% of the total active weight (as used herein, the “percent of softener active” containing a given R¹ group is based upon taking a percentage of the total active based upon the percentage that the given R¹ group is, of the total R¹ groups present.). Non-limiting examples of preferred diester quats for the present invention include N,N-di(tallowoyloxyethyl)-N,N-dimethylammonium chloride (available from Akzo under the trade name Armosoft® DEQ) and N,N-di(canola-oyloxyethyl)-N,N-dimethylammonium chloride (available from Degussa under the trade name Adogen® CDMC). Nonlimiting examples of available TEA ester quats suitable for the present invention include di-(hydrogenated tallowoyloxyethyl)-N,N-methylhydroxyethylammonium methylsulfate and di-(oleoyloxyethyl)-N,N-methylhydroxyethylammonium methylsulfate sold under the trade names Rewoquat® WE 15 and Varisoft® WE 16, both available from Degussa.

Additional preferred DEQA (1) actives include compounds comprising different Y structures such as the those having the structure below where one Y═—C(O)—O— and the other Y═—NH—C(O)—:
R¹—C(O)O—R²—N⁺(R⁴)ₙ—R³—N(H)—C(O)—R¹X⁻
wherein n is 1 or 2; R¹ is a C₆-C₂₂, preferably a C₈-C₂₀, hydrocarbyl group or substituted hardrocarbyl groups that are branched or unbranched and saturated or unsaturated; R² and R³ are each C₁-C₅, preferably C₂-C₃, alkyl or alkylene groups; and R⁴ is H, or a C₁-C₃ alkyl or hydroxyalkyl group. Non-limiting examples of such softeners are described in U.S. Pat. No. 5,580,481 and U.S. Pat. No. 5,476,597.

Other suitable fabric softening actives include reaction products of fatty acids with dialkylenetriamines in, e.g., a molecular ratio of about 2:1, said reaction products containing compounds of the formula:
R¹—C(O)—NH—R²—NH—R³—NH—C(O)—R¹
wherein R¹, R² are defined as above, and each R³ is a C₁₋₆ alkylene group, preferably an ethylene group. Examples of these fabric softening actives are reaction products of tallow acid, canola acid, or oleic acids with diethylenetriamine in a molecular ratio of about 2:1, said reaction product mixture containing N,N″-ditallowoyldiethylenetriamine, N,N″-dicanola-oyldiethylenetriamine, or N,N″-dioleoyldiethylenetriamine, respectively, with the formula:
R¹—C(O)—NH—CH₂CH₂—NH—CH₂CH₂—NH—C(O)—R¹
wherein R² and R³ are divalent ethylene groups, R¹ is defined above and an acceptable examples of this structure when R¹ is the oleoyl group of a commercially available oleic acid derived from a vegetable or animal source, include Emersol® 223LL or Emersol® 7021, available from Henkel Corporation.

Another fabric softening active for use in the present compositions has the formula:
[R¹—C(O)—NR—R²—N(R)₂—R³—NR—C(O—R¹]⁺X⁻
wherein R, R¹, R², R³ and X⁻ are defined as above. Examples of this fabric softening active are the di-fatty amidoamines based softener having the formula:
[R¹—C(O)—NH—CH₂CH₂—N(CH₃)(CH₂CH₂OH)—CH₂CH₂—NH—C(O)—R¹]⁺CH₃SO₄⁻
wherein R¹—C(O) is an oleoyl group, soft tallow group, or a hardened tallow group available commercially from Degussa under the trade names Varisoft® 222LT, Varisoft® 222, and Varisoft® 110, respectively.

A second type of DEQA (“DEQA (2)”) compound suitable as a fabric softening active in the present compositions has the general formula:
[R₃N⁺CH₂CH(YR¹)(CH₂YR¹)]X⁻
wherein each Y, R, R¹, and X⁻ have the same meanings as before. Such compounds include those having the formula:
[CH₃]₃N⁽⁺⁾[CH₂CH(CH₂O(O)CR¹)O(O)CR¹]Cl⁽⁻⁾
wherein each R is a methyl or ethyl group and preferably each R¹ is in the range of C₁₅ to C₁₉. As used herein, when the diester is specified, it can include the monoester that is present. The amount of monoester that can be present is the same as in DEQA (1).

These types of agents and general methods of making them are disclosed in U.S. Pat. No. 4,137,180, Naik et al., issued Jan. 30, 1979, which is incorporated herein by reference. An example of a preferred DEQA (2) is the “propyl” ester quaternary ammonium fabric softener active having the formula 1,2-di(acyloxy)-3-trimethylammoniopropane chloride.

While it is acceptable to use fabric softening compounds with any transition temperature; preferably, for the present invention, the fabric softening compound has a transition temperature of equal to or less than about 50° C. While it is acceptable for fabric softening compounds to be made with fatty acid precursors with a range of Iodine Values (herein referred to as IV) from zero to about 140, it is preferred for some aspects of the present invention to use softening compounds made with fatty acid precursors having an IV of at least about 40. These aspects include, but are not limited to, physical characteristics of the fabric softening composition and static performance. For other aspects of the present invention, an IV of about 15 to about 40 is preferable to improve the softening efficiency.

Fabric softening compositions of the present invention that are clear preferably contain highly fluid fabric softening actives with transition temperatures less than about 35° C. These materials can be made with fatty acid precursors having high IV (greater than about 50) or comprising branching or other structural modifications leading to a low transition temperature. Additionally when unsaturated fabric softener actives are used for clear compositions the unsaturated moiety preferably has a cis:trans isomer ratio of at least 1:1, preferably about 2:1, more preferably about 3:1, and even more preferably 4:1 or higher. Some preferred actives for clear compositions are disclosed in U.S. Pat. No. 6,369,025; U.S. application Ser. No. 09/554,969, filed Nov. 24, 1998 by Frankenbach et al. (WO 99/27050); and U.S. Pat. No. 6,486,121.

While it is acceptable for the present invention for the composition to contain a number of softening actives, including other fabric softening actives disclosed herein below, the DEQA fabric softening actives, and specifically those fabric softener actives with two ester linkages, are preferred fabric softening actives for the present invention.

Other Fabric Softening Actives

Instead of, or in addition to, the DEQA fabric softening actives described hereinbefore, the present compositions can also comprise a variety of other fabric softening actives. These other suitable fabric softening actives include:
(1) compounds having the formula:
   [R₄₋ₘ—N⁽⁺⁾—R¹ₘ] A⁻
   wherein each m is 2 or 3, each R¹ is a C₆-C₂₂, preferably C₁₄-C₂₀, but no more than one being less than about C₁₂ and then the other is at least about 16, hydrocarbyl, or substituted hydrocarbyl substituent, preferably C₁₀-C₂₀ alkyl or alkenyl (unsaturated alkyl, including polyunsaturated alkyl, also referred to sometimes as “alkylene”), most preferably C₁₂-C₁₈ alkyl or alkenyl, and branch or unbranced. While it is acceptable for the IV of the parent fatty acid containing the R¹ group to range from zero to about 140, it is preferred for the present invention to have an IV of at least about 40. When the fabric softener composition will be clear, it is preferred for fabric softner active to be highly fluid by incorporating branching in the hydrocarbyl group by incorporating high unsaturation e.g. the IV of a fatty acid containing this R¹ group is from about 70 to about 140, more preferably from about 80 to about 130; and most preferably from about 90 to about 115 (as used herein, the term “Iodine Value” means the Iodine Value of a “parent” fatty acid, or “corresponding” fatty acid, which is used to define a level of unsaturation for an R¹ group that is the same as the level of unsaturation that would be present in a fatty acid containing the same R¹ group) with, preferably, a cis/trans ratio as specified above for highly unsaturated compounds; each R is H or a short chain C₁-C₆, preferably C₁-C₃ alkyl or hydroxyalkyl group, e.g., methyl (most preferred), ethyl, propyl, hydroxyethyl, and the like, benzyl, or (R²O)₂₋₄H where each R² is a C₁₋₆ alkylene group; and A⁻ is a softener compatible anion, preferably, chloride, bromide, methylsulfate, ethylsulfate, sulfate, phosphate, or nitrate; more preferably chloride or methyl sulfate. Examples of these fabric softening actives include dialkydimethylammonium salts and dialkylenedimethylammonium salts such as ditallowdimethylammonium chloride, dicanoladimethylammonium chloride, and dicanoladimethylammonium methylsulfate. Examples of commercially available dialkylenedimethylammonium salts usable in the present invention are di-hydrogenated tallow dimethyl ammonium chloride, ditallowdimethyl ammonium chloride, and dioleyldimethylammonium chloride available from Degussa under the trade names Adogen® 442, Adogen® 470, and Adogen® 472, respectively.
(2) compounds having the formula: 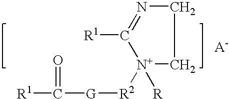
   wherein each R, R¹, and A⁻ have the definitions given above; each R² is a C₁₋₆ alkylene group, preferably an ethylene group; and G is an oxygen atom or an —NR— group. Examples of this fabric softening active are 1-methyl-1-tallowylamidoethyl-2-oleylimidazolinium methylsulfate and 1-methyl-1-oleylamidoethyl-2-oleylimidazolinium methylsulfate wherein R¹ is an acyclic aliphatic C₁₅-C₁₇ hydrocarbon group, R² is an ethylene group, G is a NH group, R⁵ is a methyl group and A⁻ is a methyl sulfate anion, available commercially from Degussa under the trade names Varisoft® 475 and Varisoft® 3690, respectively.
(3) compounds having the formula: 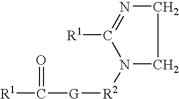
   wherein R¹, R² and G are defined as above. An example of this fabric softening active is 1-oleylamidoethyl-2-oleylimidazoline wherein R¹ is an acyclic aliphatic C₁₅-C₁₇ hydrocarbon group, R² is an ethylene group, and G is a NH group.

(4) reaction products of substantially unsaturated and/or branched chain higher fatty acid with hydroxyalkylalkylenediamines in a molecular ratio of about 2:1, said reaction products containing compounds of the formula:
R¹—C(O)—NH—R²—N(R³OH)—C(O)—R¹
wherein R¹, R² and R³ are defined as above. Examples of this fabric softening active are reaction products of fatty acids such as tallow fatty acid, oleic fatty acid, or canola fatty acid with N-2-hydroxyethylethylenediamine in a molecular ratio of about 2:1, said reaction product mixture containing a compound of the formula:
R¹—C(O)—NH—CH₂CH₂—N(CH₂CH₂OH)—C(O)—R¹
wherein R¹—C(O) is oleoyl, tallowyl, or canola-oyl group of a commercially available fatty acid derived from a vegetable or animal source. Nonlimiting examples of such actives include Emersol® 223LL or Emersol® 7021, which are derived from oleic acid and available from Henkel Corporation.

(5) compounds having the formula: 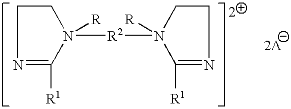
wherein R, R¹, R², and A⁻ are defined as above.

Other compounds suitable as fabric softening actives herein are acyclic quaternary ammonium salts having the formula:
[R¹—N(R⁵)₂—R⁶]⁻A⁻
wherein R⁵ and R⁶ are C₁-C₄ alkyl or hydroxyalkyl groups, and R¹ and A⁻ are defined as herein above. Examples of these fabric softening actives are the monoalkyltrimethylammonium salts and the monoalkenyltrimethylammonium salts such as monotallowyltrimethylammonium chloride, monostearyltrimethylammonium chloride, monooleyltrimethylammonium chloride, and monocanolatrimethylammonium chloride. Commercial examples include tallowtrimetylammonium chloride and soyatrimethylammonium chloride available from Degussa under the trade names Adogen® 471 and Adogen® 415.

(6) substituted imidazolinium salts having the formula: 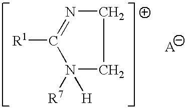
wherein R⁷ is hydrogen or a C₁-C₄ saturated alkyl or hydroxyalkyl group, and R¹ and A⁻ are defined as hereinabove;
(7) substituted imidazolinium salts having the formula: 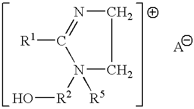
   wherein R⁵ is a C₁-C₄ alkyl or hydroxyalkyl group, and R¹, R², and A⁻ are as defined above;
(8) alkylpyridinium salts having the formula: 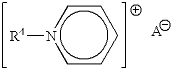
   wherein R⁴ is an acyclic aliphatic C₈-C₂₂ hydrocarbon group and A⁻ is an anion. An example of this fabric softening active is 1-ethyl-1-(2-hydroxyethyl)-2-isoheptadecylimidazolinium ethylsulfate wherein R¹ is a C₁₇ hydrocarbon group, R² is an ethylene group, R⁵ is an ethyl group, and A⁻ is an ethylsulfate anion.
(9) alkanamide alkylene pyridinium salts having the formula: 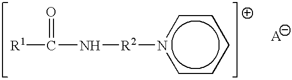
   wherein R¹, R² and A⁻ are defined as herein above; and mixtures thereof.

Other suitable fabric softening actives for use in the present compositions include pentaerythritol compounds. Such compounds are disclosed in more detail in, e.g., U.S. Pat. No. 6,492,322; U.S. Pat. No. 6,194,374; U.S. Pat. No. 5,358,647; U.S. Pat. No. 5,332,513; U.S. Pat. No. 5,290,459; U.S. Pat. No. 5,750,990, U.S. Pat. No. 5,830,845; U.S. Pat. No. 5,460,736 and U.S. Pat. No. 5,126,060.

Polyquaternary ammonium compounds can also be useful as fabric softening actives in the present compositions and are described in more detail in the following patent documents: EP 803,498; GB 808,265; GB 1,161,552; DE 4,203,489; EP 221,855; EP 503,155; EP 507,003; EP 803,498; FR 2,523,606; JP 84-273918; JP 2-011,545; U.S. Pat. No. 3,079,436; U.S. Pat. No. 4,418,054; U.S. Pat. No. 4,721,512; U.S. Pat. No. 4,728,337; U.S. Pat. No. 4,906,413; U.S. Pat. No. 5,194,667; U.S. Pat. No. 5,235,082; U.S. Pat. No. 5,670,472; Weirong Miao, Wei Hou, Lie Chen, and Zongshi Li, Studies on Multifunctional Finishing Agents, Riyong Huaxue Gonye, No. 2, pp. 8-10, 1992; Yokagaku, Vol. 41, No. 4 (1992); and Disinfection, Sterilization, and Preservation, 4^{th} Edition, published 1991 by Lea & Febiger, Chapter 13, pp. 226-30. The products formed by quaternization of reaction products of fatty acid with N,N,N′,N′, tetraakis(hydroxyethyl)-1,6-diaminohexane are also suitable for use in the present invention.

Examples of ester and/or amide linked fabric softening actives useful in the present invention, especially for concentrated clear compositions, are disclosed in U.S. Pat. No. 5,759,990 and U.S. Pat. No. 5,747,443. Other fabric softening actives for clear liquid fabric softening compositions are described in U.S. Pat. No. 6,323,172.

Examples of suitable amine softeners that can be used in the present invention as fabric softening actives are disclosed in U.S. Pat. No. 6,630,441.

Other fabric softening actives that can be used herein are disclosed, at least generically for the basic structures, in U.S. Pat. No. 3,861,870; U.S. Pat. No. 4,308,151; U.S. Pat. No. 3,886,075; U.S. Pat. No. 4,233,164; U.S. Pat. No. 4,401,578; U.S. Pat. No. 3,974,076; and U.S. Pat. No. 4,237,016. Examples of more biodegradable fabric softeners can be found in U.S. Pat. No. 3,408,361; U.S. Pat. No. 4,709,045; U.S. Pat. No. 4,233,451; U.S. Pat. No. 4,127,489; U.S. Pat. No. 3,689,424; U.S. Pat. No. 4,128,485; U.S. Pat. No. 4,161,604; U.S. Pat. No. 4,189,593; and U.S. Pat. No. 4,339,391.

The fabric softening active in the present compositions is preferably selected from the group consisting of ditallowoyloxyethyl dimethyl ammonium chloride, dihydrogenated-tallowoyloxyethyl dimethyl ammonium chloride, dicanola-oyloxyethyl dimethyl ammonium chloride, ditallow dimethyl ammonium chloride, tritallow methyl ammonium chloride, methyl bis(tallow amidoethyl)2-hydroxyethyl ammonium methyl sulfate, methyl bis(hydrogenated tallow amidoethyl)-2-hydroxyethyl ammonim methyl sulfate, methyl bis(oleyl amidoethyl)-2-hydroxyethyl ammonium methyl sulfate, ditallowoyloxyethyl dimethyl ammonium methyl sulfate, dihydrogenated-tallowoyloxyethyl dimethyl ammonium chloride, dicanola-oyloxyethyl dimethyl ammonium chloride, N-tallowoyloxyethyl-N-tallowoylaminopropyl methyl amine, 1,2-bis(hardened tallowoyloxy)-3-trimethylammonium propane chloride, and mixtures thereof.

It will be understood that all combinations of fabric softening actives disclosed above are suitable for use in this invention.

Aqueous Carrier

The present compositions will generally comprise an aqueous carrier comprising water. The level of aqueous carrier generally constitutes the balance of the present compositions.

Adjunct Ingredients

The present compositions optionally, but preferably, comprise additional adjunct ingredients, preferably selected from the group consisting of electrolyte, pH modifier, phase stabilizing polymer, perfume, non-aqueous solvent, fatty acid, dye, preservatives, optical brighteners, antifoam agents, anionic scavengers, and mixtures thereof. The amount of each optional adjunct ingredient is typically up to about 2.0%, by weight of the composition, unless otherwise specified.

Electrolyte

Electrolyte is an optional, but preferred, additive for compositions of the present invention. Electrolyte is especially preferred in compositions comprising at least 10% fabric softening active, by weight. Electrolyte is preferably included in dispersion compositions of the present invention to achieve preferred viscosity of equal to or less than about 2000 centipoise, preferably less than about 200 centipoise. Electrolyte is preferably included in clear compositions to modify the viscosity/elasticity profile of the composition on dilution and to provide lower viscosity and/or elasticity to the composition itself. Additionally, for clear compositions, the electrolyte is a highly preferred additive enabling the use of lower solvent levels to achieve an economically feasible clear composition, while still maintaining a preferred viscosity of equal to or less than about 200 centipoise for the composition as well as providing preferred lower viscosity upon dilution.

Suitable electrolytes for incorporation in the present compositions include inorganic salts. Non-limiting examples of suitable inorganic salts include: MgI₂, MgBr₂, MgCl₂, Mg(NO₃)₂, Mg₃(PO₄)₂, Mg₂P₂O₇, MgSO₄, magnesium silicate, NaI, NaBr, NaCl, NaF, Na₃(PO₄), NaSO₃, Na₂SO₄, Na₂SO₃, NaNO₃, NaIO₃, Na₃(PO₄), Na₄P₂O₇, sodium silicate, sodium metasilicate, sodium tetrachloroaluminate, sodium tripolyphosphate (STPP), Na₂Si₃O₇, sodium zirconate, CaF₂, CaCl₂, CaBr₂, CaI₂, CaSO₄, Ca(NO₃)₂, Ca, KI, KBr, KCl, KF, KNO₃, KNO₃, K₂SO₄, K₂SO₃, K₃(PO₄), K₄(P₂₀₇), potassium pyrosulfate, potassium pyrosulfite, LiI, LiBr, LiCl, LiF, LiNO₃, AlF₃, AlCl₃, AlBr₃, AlI₃, Al₂(SO₄)₃, Al(PO₄), Al(NO₃)₃, aluminum silicate; including hydrates of these salts and including combinations of these salts or salts with mixed cations e.g. potassium alum AlK(SO₄)₂ and salts with mixed anions, e.g. potassium tetrachloroaluminate and sodium tetrafluoroaluminate. Salts incorporating cations from groups IIIa, IVa, Va, VIIa, VIIa, VIII, Ib, and IIb on the periodic chart with atomic numbers >13 are also useful in reducing dilution viscosity but less preferred due to their tendency to change oxidation states and thus they can adversely affect the odor or color of the formulation or lower weight efficiency. Salts with cations from group Ia or Ia with atomic numbers >20 as well as salts with cations from the lactinide or actinide series are useful in reducing dilution viscosity, but less preferred. Mixtures of above salts are also useful.

Other suitable electrolytes for incorporation in the present compositions include organic salts. Non-limiting examples of suitable organic salts include, magnesium, sodium, lithium, potassium, zinc, and aluminum salts of the carboxylic acids including formate, acetate, proprionate, pelargonate, citrate, gluconate, lactate aromatic acids e.g. benzoates, phenolate and substituted benzoates or phenolates, such as phenolate, salicylate, polyaromatic acids terephthalates, and polyacids e.g. oxylate, adipate, succinate, benzenedicarboxylate, benzenetricarboxylate. Other useful organic salts include carbonate and/or hydrogencarbonate (HCO₃⁻¹) when the pH is suitable, alkyl and aromatic sulfates and sulfonates e.g. sodium methyl sulfate, benzene sulfonates and derivatives such as xylene sulfonate, and amino acids when the pH is suitable. Electrolytes can comprise mixed salts of the above, salts neutralized with mixed cations such as potassium/sodium tartrate, partially neutralized salts such as sodium hydrogen tartrate or potassium hydrogen phthalate, and salts comprising one cation with mixed anions.

Generally, inorganic electrolytes are preferred over organic electrolytes for better weight efficiency and lower costs. Mixtures of inorganic and organic salts can be used. Typical levels of electrolyte in the compositions of the present invention are from about 0.001% to about 10%, by weight of the composition. Preferred levels of electrolyte for dispersion compositions are typically from about 0.001% to about 3%, preferably from about 0.01% to about 2%, and more preferably from about 0.05% to about 1%. Preferred levels of electrolyte for clear compositions are from about 0.5% to about 5%, preferably from about 0.75% to about 2.5%, and more preferably from about 1% to about 2%, by weight of the composition.

Phase Stabilizing Polymers

Optionally, the compositions herein further comprise from 0% to about 10%, preferably from about 0.1% to about 5%, more preferably from about 0.1% to about 2%, of a phase stabilizing polymer. Phase stabilizing polymers useful in the present invention include copolymeric blocks of terephthalate and polyethylene oxide or polypropylene oxide, and the like. Preferred phase stabilizing polymers comprising cationic functionalities are disclosed in U.S. Pat. No. 4,956,447.

A preferred phase stabilizing polymer is a copolymer having blocks of terephthalate and polyethylene oxide. More specifically, these polymers are comprised of repeating units of ethylene and/or propylene terephthalate and polyethylene oxide terephthalate at a molar ratio of ethylene terephthalate units to polyethylene oxide terephthalate units of from about 25:75 to about 35:65, said polyethylene oxide terephthalate containing polyethylene oxide blocks having molecular weights of from about 300 to about 2000. The molecular weight of this phase stabilizing polymer is in the range of from about 5,000 to about 55,000.

Another preferred phase stabilizing polymer is a crystallizable polyester with repeat units of ethylene terephthalate units containing from about 10% to about 15% by weight of ethylene terephthalate units together with from about 10% to about 50% by weight of polyoxyethylene terephthalate units, derived from a polyoxyethylene glycol of average molecular weight of from about 300 to about 6,000, and the molar ratio of ethylene terephthalate units to polyoxyethylene terephthalate units in the crystallizable polymeric compound is between 2:1 and 6:1. Examples of this polymer include the commercially available materials ZELCON® 4780 (from DuPont) and MILEASE® T (from ICI).

Highly preferred phase stabilizing polymers are described in more detail in U.S. Pat. No. 5,574,179 at col. 14, line 66 to col. 15, line 67; in U.S. Pat. No. 4,861,512; and in U.S. Pat. No. 4,702,857.

The present compositions preferably further comprise perfume. Perfume is typical incorporated in the present compositions at a level of at least about 0.001%, preferably at least about 0.01%, more preferably at least about 0.1%, and no greater than about 10%, preferably no greater than about 5%, more preferably no greater than about 3%, by weight of the composition.

The present compositions can optionally further comprise solvents. Suitable solvents can be water-soluble or water-insoluble and can include ethanol, propanol, isopropanol, n-butanol, t-butanol, propylene glycol, ethylene glycol, dipropylene glycol, propylene carbonate, butyl carbitol, phenylethyl alcohol, 2-methyl 1,3-propanediol, hexylene glycol, glycerol, polyethylene glycol, 1,2-hexanediol, 1,2-pentanediol, 1,2-butanediol, 1,4-cyclohexanediol, pinacol, 1,5-hexanediol, 1,6-hexanediol, 2,4-dimethyl-2,4-pentanediol, 2,2,4-trimethyl-1,3-pentanediol, 2-ethyl-1,3-hexanediol, phenoxyethanol, or mixtures thereof. Solvents are typically incorporated in the present compositions at a level of less than about 40%, preferably from about 0.5% to about 25%, more preferably from about 1% to about 10%, by weight of the composition. Preferred solvents, especially for clear compositions herein, have a ClogP of from about −2.0 to about 2.6, preferably from about −1.7 to about 1.6, and more preferably from about −1.0 to about 1.0, which are described in detail in U.S. application Ser. No. 09/554,969, filed Nov. 24, 1998 by Frankenbach et al. (WO 99/27050).

The present compositions can optionally further comprise fatty acid. Suitable fatty acids include those containing from about 12 to about 25, preferably from about 13 to about 22, more preferably from about 16 to about 20, total carbon atoms, with the fatty moiety containing from about 10 to about 22, preferably from about 10 to about 18, more preferably from about 10 to about 14 (mid cut), carbon atoms. The shorter moiety contains from about 1 to about 4, preferably from about 1 to about 2 carbon atoms.

While the present compositions can further comprise additional optional components such as oily sugar derivatives, such as those disclosed in WO 01/46361 and U.S. Pat. No. 6,514,931, the compositions are preferably free of these oily sugar derivatives. The present compositions can also further comprise optional anionic surfactants. However, if anionic surfactants are present, they are preferably included at a level of less than about 5%, preferably from about 0.1% to about 1%, by weight of the composition. The present compositions can also be free of anionic surfactants.

The present compositions can be liquid or solid, and are preferably liquid compositions. Liquid compositions of the present invention can be clear or opaque (dispersions). Solid compositions of the present invention can be incorporated onto a substrate material, preferably a nonwoven substrate material, for use in treating fabrics in a laundry dryer. Suitable substrate materials are described in U.S. Pat. No. 5,929,026; U.S. Pat. No. 5,883,069; and U.S. Pat. No. 5,470,492. The present compositions can also be provided in a unit dose form, for example, as a liquid composition contained in a water-soluble film (e.g. polyvinyl alcohol film) or as a solid tablet unit dose form.

The liquid compositions of the present invention will typically have a viscosity of less than about 2000 centipoise, preferably less than about 500 centipoise, more preferably less than about 200 centipoise, and even more preferably less than about 120 centipoise. For purposes of the present invention, the viscosities of the present compositions are measured at 25° C. with a Brookfield® viscometer using a No. 2 spindle at 60 rpm.

The present compositions will generally have a pH of from about 2 to about 5, preferably from about 2 to about 4.5, and more preferably from about 2.5 to about 4.

The present compositions can be used to treat fabrics during the wash cycle, rinse cycle, and/or drying cycle of a laundering process. The present invention thus further relates to methods of treating fabrics to provide one or more benefits selected from the group consisting of improved fabric softness, wrinkle reduction after drying, ease of ironing, in-wear shape retention, fabric elasticity, fabric tensile strength, fabric tear strength, and color protection; the method comprising the step of contacting the fabrics with an effective amount of a fabric care composition of the present invention. The present invention further relates to the use of the present compositions to provide one or more technical effect selected from the group consisting of improved fabric softness, wrinkle reduction after drying, ease of ironing, in-wear shape retention, fabric elasticity, fabric tensile strength, fabric tear strength, and color protection.

Process of Manufacture

The compositions of the present invention can be manufactured by mixing together the various components of the compositions described herein. In a preferred process of manufacture, an aminosilicone emulsion is made by mixing an aminosilicone having an amino content ratio of from about 1:11 to about 1:269 with a cationic emulsifier. A preferred cationic emulsifier is cetyltrimethylammonium chloride.

A preferred process for making the fabric care compositions comprises the steps of providing an aminosilicone emulsion formed by mixing an aminosilicone with an emulsifier, dispersing a molten fabric softening active in water having a temperature above the transition temperature of the fabric softening active under mechanical shear to form a dispersion, mixing the remaining components of the fabric care composition into the dispersion, cooling the dispersion, and then mixing the aminosilicone emulsion with the dispersion to form the present fabric care composition. In a preferred process, the perfume and dye components of the composition are added after addition of the aminosilicone emulsion after the cooling step.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and claims, are by weight and all numerical limits are used with the normal degree of accuracy afforded by the art, unless otherwise specified.

The following are non-limiting examples of the fabric care compositions of the present invention.

| | EXAMPLE | | | | |
|---|---|---|---|---|---|
| INGREDIENTS | I | II | III | IV | V |
| REWOQUAT ® V3282^{a} | 18.98% | 18.98% | 18.98% | 18.98% | 6.3% |
| DC2-8822A Polymer^{b} | 3.00% | 3.00% | 3.00% | 3.00% | 1.0% |
| Perfume | 1.05% | 1.05% | 1.05% | 1.00% | 0.3% |
| Hydrochloric Acid | 0.11% | 0.11% | 0.11% | 0.02% | 0.01% |
| Polyoxyethylene(12) | 0.39% | 0.09% | — | 0.03% | 0.01% |
| tridecyl ether | | | | | |
| NEODOL ® 91-5^{c} | 0.21% | — | — | — | — |
| Cetyltrimethylammonium | — | 0.21% | 0.30% | 0.3% | 0.1% |
| chloride | | | | | |
| Bis DMAPA^{d} | 0.15% | 0.15% | 0.15% | — | — |
| Antifoam^{e} | 0.008% | 0.008% | 0.008% | 0.008% | 0.008% |
| Phase Stabilizing | 0.05% | 0.05% | 0.05% | — | — |
| Polymer^{f} | | | | | |
| Na HEDP^{g} | 0.008% | 0.008% | 0.008% | — | — |
| CaCl2 | — | — | — | 0.1% | — |
| Dye | 22 ppm | 22 ppm | 22 ppm | 22 ppm | 11 ppm |
| Deionized Water | Balance | Balance | Balance | Balance | Balance |

^{a}Fabric softening active comprising N,N-di(tallowoyloxyethyl)-N,N-dimethylammonium chloride available from Degussa.
^{b}Aminosilicone polymer commercially-available from Dow Corning.
^{c}C₉₋₁₁ alkyl EO 5 nonionic surfactant available from Shell Chemical.
^{d}Bis-Dimethylaminopropylamine.
^{e}Silicone antifoam agent available from Dow Corning under the trade name MP10.
^{f}Copolymer of ethylene oxide and terephthalate having the formula described in U.S. Pat. No. 5,574,179 at col. 15, lines 1-5, wherein each X is methyl, each n is 40, u is 4, each R¹ is essentially 1,4-phenylene moieties, each R² is essentially ethylene, 1,2-propylene moieties, or mixtures thereof.
^{g}Hydroxyethylenedipropionic acid, monosodium salt.

### EXAMPLES VI-X

Examples VI-X are examples of the compositions of the present invention that are the same as Examples I-V, except that the aminosilicone DC2-8822A is substituted by an aminosilicone DC2-8040 available from Dow Corning.

### EXAMPLE XI

The following is a non-limiting example of a process for making an aminosilicone emulsion comprising 35% aminosilicone (DC2-8822A), 3.5% cationic emulsifier (cetyltrimethylammonium chloride-25% active in water), and the balance water. Mix 140 g of DC2-8822A with 56 g cetyltrimethylammonium chloride at 1900 rpm with a mechanical overhead stirrer (Eurostar from IKA) until the mixture becomes a thick homogeneous white phase (approximately 10 minutes). Inject 204 g water at a rate of about 1 g water/s on the mixer blade with a “Masterflex L/S™ Modular controller” pump, to achieve a homogeneous emulsion of water-in-silicone, which slowly inverts and transforms into the silicone-in-water emulsion. Decrease the mixer speed slowly as the viscosity decreases. Continue mixing for about 10 minutes after all the water is injected to ensure good homogenization. If all the water is injected and the emulsion still contains some non-emulsified aminosilicone, then include an extra homogenization step by mixing with an “Ultra Turrax T25 from IKA” for about 3 minutes at 8000 rpm.

### EXAMPLE XII

The following is a non-limiting example of a process of making a fabric care composition of the present invention. Heat 73.857 parts demineralized water to a temperature of 65° C. and then add 0.04 parts hydrochloric acid. Heat 16 parts fabric softening active (REWOQUAT® V3282) to a temperature of 75° C. Disperse the fabric softening active in the water under strong agitation. Add 0.1 parts calcium chloride to the mixture under agitation. Cool the mixture to room temperature. Mix 9 parts of the aminosilicone emulsion of Example XI to the mixture under agitation. Add 1 part perfume and 0.003 parts dye to the mixture under agitation to form a fabric care composition of the present invention.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A fabric care composition comprising:
an aminosilicone having a formula:
(R¹R²R³SiO_{1/2})ₚ(R⁴R⁴SiO_{2/2})ₘ[R⁴Si(L-NR⁵R⁶)O_{2/2}]ₐ[Si(K—NR⁷R⁸)O_{3/2}]_{b}[R⁴SiO_{3/2}]_{c}
wherein R¹, R², R³ and R⁴ are independently (1) C₁-C₂₂ linear or branched, substituted or unsubstituted hydrocarbyl moiety, or (2) —O—R¹¹, —O—R¹², —O—R³, and —O—R ¹⁴, wherein R¹¹, R¹², R¹³, and R¹⁴ are independently H or C₁-C₂₂ linear or branched, substituted or unsubstituted hydrocarbyl moiety; L and K are independently C₁-C₂₂ linear or branched, substituted or unsubstituted hydrocarbyl moiety; R⁵, R⁶, R⁷ and R⁸ are independently H or C₁-C₂₂ linear or branched, substituted or unsubstituted hydrocarbyl moiety; wherein a, b, c, m, and p are independently integers from 0 to 6,000, wherein p is equal to 2+b+c; and wherein said aminosilicone has an amino content ratio (a+b):(a+b+c+m+p) of from about 1:11 to about 1:269;
an emulsifier selected from the group consisting of cationic emulsifier, nonionic emulsifier, and mixtures thereof; and
a fabric softening active.

2. The fabric care composition of claim 1, wherein said aminosilicone and said emulsifier are pre-mixed to form an aminosilicone emulsion which is then utilized to form said fabric care composition.

3. The fabric care composition of claim 1, wherein said aminosilicone has an amino content ratio of from about 1:16 to about 1:135.

4. The fabric care composition of claim 3, wherein said aminosilicone has an amino content ratio of from about 1:22 to about 1:68.

5. The fabric care composition of claim 1, wherein said composition comprises from about 0.05% to about 30%, by weight of said composition, of said aminosilicone.

6. The fabric care composition of claim 5, wherein said composition comprises from about 0.08% to about 10%, by weight of said composition, of said aminosilicone.

7. The fabric care composition of claim 6, wherein said composition comprises from about 0.5% to about 6%, by weight of said composition, of said aminosilicone.

8. The fabric care composition of claim 1, wherein said aminosilicone has a viscosity of from about 200 to about 10,000 cps.

9. The fabric care composition of claim 8, wherein said aminosilicone has a viscosity of from about 500 to about 5,000 cps.

10. The fabric care composition of claim 9, wherein said aminosilicone has a viscosity of from about 800 to about 3,000 cps.

11. The fabric care composition of claim 1, wherein said aminosilicone is a linear aminosilicone; wherein b and c are zero.

12. The fabric care composition of claim 1, wherein said aminosilicone is a branched aminosilicone; wherein b and/or c is at least 1.

13. The fabric care composition of claim 12, wherein said branched aminosilicone has a branching ratio (c+b):(a+b+c+m+p) of from about 1:45 to about 1:500.

14. The fabric care composition of claim 1, wherein said L and K are independently methylene, ethylene, propylene, 2-methylpropylene, butylene, octadecylene, or 3-(2,2′,6,6′-tetramethyl-4-oxy-piperidyl)propyl; and said R⁵, R⁶, R⁷ and R⁸ are independently H, phenyl, cyclohexyl, phenyl, 2-aminoethyl, 2-(N-2-aminoethyl) aminoethyl, 2-[N-2-(N-2-aminoethyl)aminoethyl]aminoethyl, 2-(N-phenyl)aminoethyl, 2-(N-cyclohexyl)aminoethyl, polyethyleneoxide, polypropyleneoxide, polyethyleneoxide-co-polypropyleneoxide, or polyethyleneoxide-co-polypropyleneoxide-co-polyethyleneamine.

15. The fabric care composition of claim 1, wherein said composition comprises from about 2% to about 90%, by weight of said composition, of fabric softening active.

16. The fabric care composition of claim 15, wherein said composition comprises from about 4% to about 40%, by weight of said composition, of fabric softening active.

17. The fabric care composition of claim 16, wherein said composition comprises from about 8% to about 30%, by weight of said composition, of fabric softening active.

18. The fabric care composition of claim 1, wherein said fabric softening active is N,N-di(tallowoyloxyethyl)-N,N-dimethylammonium chloride.

19. The fabric care composition of claim 1, wherein said emulsifier is selected from the group consisting of alkyltrimethylammonium chloride, ethoxylated alkyl alcohol, polyoxyethylene alcohols, and mixtures thereof.

20. The fabric care composition of claim 19, wherein said emulsifier is cetryltrimethylammonium chloride, polyoxyethylene(12)tridecyl ether, or mixtures thereof.

21. The fabric care composition of claim 1, wherein said composition comprises from about 0.01% to about 5%, by weight of the composition, of emulsifier.

22. The fabric care composition of claim 21, wherein said composition comprises from about 0.03% to about 2%, by weight of the composition, of emulsifier.

23. The fabric care composition of claim 22, wherein said composition comprises from about 0.05% to about 1%, by weight of the composition, of emulsifier.

24. The fabric care composition of claim 1, wherein said composition further comprises perfume.

25. A method of softening fabrics comprising the step of contacting said fabrics with an effective amount of a fabric care composition according to claim 1.

26. A process of making an aminosilicone emulsion, said process comprising the step of mixing an aminosilicone having an amino content ratio of from about 1:11 to about 1:269 with a cationic emulsifier.

27. A process of making a fabric care composition comprising the steps of providing an aminosilicone emulsion formed by mixing an aminosilicone with an emulsifier, dispersing a molten fabric softening active in water having a temperature above the transition temperature of said fabric softening active to form a dispersion, mixing adjunct components of said fabric care composition into said dispersion, cooling said dispersion, and mixing said aminosilicone emulsion with said dispersion to form said fabric care composition.
